(19) United States
(12) Patent Application Publication
(10) Pub. No.: US 2012/0063366 A1
(43) Pub. Date: Mar. 15, 2012

(54) METHOD AND APPARATUS FOR CALL CONTROL IN A COMMUNICATIONS NETWORK

(75) Inventor: Shuiping LONG, Shenzhen (CN)

(73) Assignee: Huawei Technologies Co., Ltd., Shenzhen (CN)

(21) Appl. No.: 13/300,477

(22) Filed: Nov. 18, 2011

Related U.S. Application Data
(63) Continuation of application No. 12/534,278, filed on Aug. 3, 2009.
Application No. 12/534,278 is a continuation of application No. PCT/CN2008/070654, filed on Apr. 1, 2008.

(30) Foreign Application Priority Data
Apr. 6, 2007 (CN) 200710090412.9

(51) Int. Cl. H04L 12/66; H04L 12/16

(52) U.S. Cl. 370/259; 370/352

(57) ABSTRACT

A call control method that includes: establishing a circuit-switched call leg with a terminal device; establishing a packet-switched call leg with a second party; and establishing a call connection between the terminal device and the second party by binding the circuit-switched call leg and the packet-switched call leg. A circuit-switched domain adapter and a terminal device are also provided to realize a call control to the circuit-switched terminal device by a packet-switched control platform.

### CROSS-REFERENCE TO RELATED APPLICATIONS

This application is a continuation of U.S. patent application Ser. No. 12/534,278, filed on Aug. 3, 2009, which is a continuation of International Patent Application No. PCT/CN2008/070654, filed on Apr. 1, 2008. The International Application claims the priority to Chinese Patent Application No. 200710090412.9, filed on Apr. 6, 2007. The aforementioned patent applications are incorporated herein by references in their entireties.

### FIELD OF THE INVENTION

The present invention relates to communications networks, and particularly to a method and apparatus for call control in a communications network.

### BACKGROUND

At present, mobile communications networks are mostly circuit-switched (CS) networks, which include Global System for Mobile Communications (GSM), Code Division Multiple Access (CDMA) and so on. Operators have built up relatively complete and rich service platforms based on CS networks in which Mobile Switching Center (MSC) is responsible for call routing and service logic executing, such as call forwarding service, call hold service and so on.

Service provision in a CS network needs to be supported by a MSC in a roaming region, which is inconvenient for introducing new services. IP Multimedia Sub-system (IMS) is a packet-switched (PS) service network in which service provision is independent from a roaming region, which facilitates the introduction of new multimedia services. The IMS supports User Equipment (UE) to obtain PS IMS multimedia services through various PS access networks.

The PS IMS network is a trend for the development of future communications networks. However, the IMS network is also a relatively complex network. It can be foreseen that thorough deployment of the PS IMS network will not be completed in a short time, and meanwhile not all CS network users could employ new IMS terminals in a short time. Therefore CS networks will coexist with IMS networks for a long time, and thus it is needed to operate CS networks and IMS networks simultaneously.

An existing technique for implementing coexistence of networks realizes the interworking between CS networks and IMS networks through specific network interfaces. For example, Media Gateway Controller (MGC) is introduced for converting different call protocols of two networks. The MGC is a logical functional entity for realizing the Media Gateway Control Function (MGCF).

Although the related art could realize the communication between CS networks and IMS networks, it encounters the following problems. In CS networks, a CS service control platform provides services for CS users, while in PS networks, an IMS service control platform provides services for IMS users. The simultaneous operation of the service control platforms of the two networks greatly increases operation costs. Moreover, when introducing new services, it is necessary to implement configurations and updates in the CS service control platform and the IMS service control platform at the same time, which brings difficulties for the introduction of the new services.

### SUMMARY

Embodiments of the present invention provide a call control method and apparatus to realize call control to a circuit-switched terminal device by a packet-switched control platform.

One embodiment of the present invention provides a call control method including: establishing a circuit-switched call leg with a terminal device; establishing a packet-switched call leg with a second party; and establishing a call connection between the terminal device and the second party by binding the circuit-switched call leg and the packet-switched call leg.

Another embodiment of the present invention provides a call control method including: receiving, by a packet-switched domain server, a call request transmitted to a called terminal device in a circuit-switched domain; routing the call request to a circuit-switched domain adapter; requesting, by the circuit-switched domain adapter, the called terminal device to establish a circuit-switched call leg; and establishing a call between an initiator of the call request and a forwarding target of the called terminal device if a message which is returned by the called terminal device and received by the packet-switched domain server through the circuit-switched domain adapter satisfies one or more preset trigger conditions.

Yet another embodiment of the present invention provides a circuit-switched domain adapter, including: a circuit call leg establishing unit, configured to establish a circuit-switched call leg with a terminal device; a packet call leg establishing unit, configured to establish a packet-switched call leg with a second party; and a call leg binding unit, configured to establish a call connection between the terminal device and the second party by binding the circuit-switched call leg and the packet-switched call leg.

A further embodiment of the present invention provides a terminal device, including: a circuit call leg establishing unit, configured to establish a circuit-switched call leg with a circuit-switched domain adapter; a control information generating unit, configured to generate call control information intended for the circuit-switched domain adapter after the circuit-switched call leg is established; and a control information transmitting unit, configured to transmit the call control information generated by the control information generating unit to the circuit-switched domain adapter through a packet-switched access network or a circuit-switched network.

As seen above, at least some embodiments of the present invention realize a call control to a circuit-switched terminal device by a packet-switched control platform through establishing a circuit-switched call leg with a terminal device, and establishing a packet-switched call connection between the terminal device and a second party under the control of a packet-switched domain server. Call control functions of a circuit-switched network are abandoned and a call control service is provided for the circuit-switched domain terminal device by the packet-switched domain server, thus centralizing control functions of the whole network, reducing network operation costs and making introduction of new services easier.

### BRIEF DESCRIPTION OF THE DRAWINGS

FIG. 1 is a flowchart of a call control method according to a first embodiment of the present invention;

FIG. 2 is a signaling flowchart of a call control method according to a second embodiment of the present invention;

FIG. 3 is a signaling flowchart of a call control method according to a third embodiment of the present invention;

FIG. 4 is a signaling flowchart of a call control method according to a fourth embodiment of the present invention;

FIG. 5 is a signaling flowchart of a call control method according to a fifth embodiment of the present invention;

FIG. 6 is a signaling flowchart of a call control method according to a sixth embodiment of the present invention;

FIG. 7 is a flowchart of a call control method according to a seventh embodiment of the present invention;

FIG. 8 is a schematic diagram of the logic structure of a circuit-switched domain adapter according to an eighth embodiment of the present invention;

FIG. 9 is a schematic diagram of the logic structure of a circuit-switched domain adapter according to a ninth embodiment of the present invention; and

FIG. 10 is a schematic diagram of the logic structure of a terminal device according to a tenth embodiment of the present invention.

### DETAILED DESCRIPTION

Call control methods and apparatuses in a communications network in accordance with embodiments of the present invention will be described in detail below.

### First Embodiment

A flowchart of a call control method is shown in FIG. 1, which includes the following steps.

In step 101, a circuit-switched call leg (CS Call Leg) is established between a terminal device and a circuit-switched domain adapter (CSA).

It would be appreciated that the terminal device may be a network device for implementing circuit-switched communication, such as a mobile phone, a fixed-line phone, a network computer, a server and so on.

In step 102, a packet-switched call leg is established between the circuit-switched domain adapter and a second party.

In step 103, the circuit-switched domain adapter establishes a call connection between the terminal device and the second party by binding the circuit-switched call leg and the packet-switched call leg.

Steps 102 and 103 may be understood as that a packet-switched call connection is established between the circuit-switched domain adapter, as a proxy for the terminal device, and the second party under the control of a packet-switched domain server.

It would be appreciated that the packet-switched domain server is a functional entity for implementing call control in a packet-switched network, which may be a Telephony Application Server (TAS), a Call Server Control Function (CSCF) server and so on.

It would be appreciated that the packet-switched domain server may be a functional entity for implementing call control in an IMS network.

In the present embodiment, the circuit-switched domain adapter establishes the packet-switched call leg with the second party under the control of the packet-switched domain server.

It would be appreciated that the circuit-switched domain adapter, as the proxy in the PS network for the terminal device, establishes a call with the second party, and the packet-switched domain server provides a call control service for a user through the proxy of the circuit-switched domain adapter.

The first embodiment of the present invention realizes a call control to the circuit-switched terminal device by a packet-switched control platform through establishing, the circuit-switched call leg between the terminal device and the circuit-switched domain adapter, and establishing the packet-switched call connection between the circuit-switched domain adapter which operates as the proxy of the terminal device and the second party under the control of the packet-switched domain server. Call control functions of a circuit-switched network are abandoned and the call control service is provided for the circuit-switched domain terminal device by the packet-switched domain server, thus centralizing control functions of the whole network, reducing network operation costs and making introduction of new services easier.

### Second Embodiment

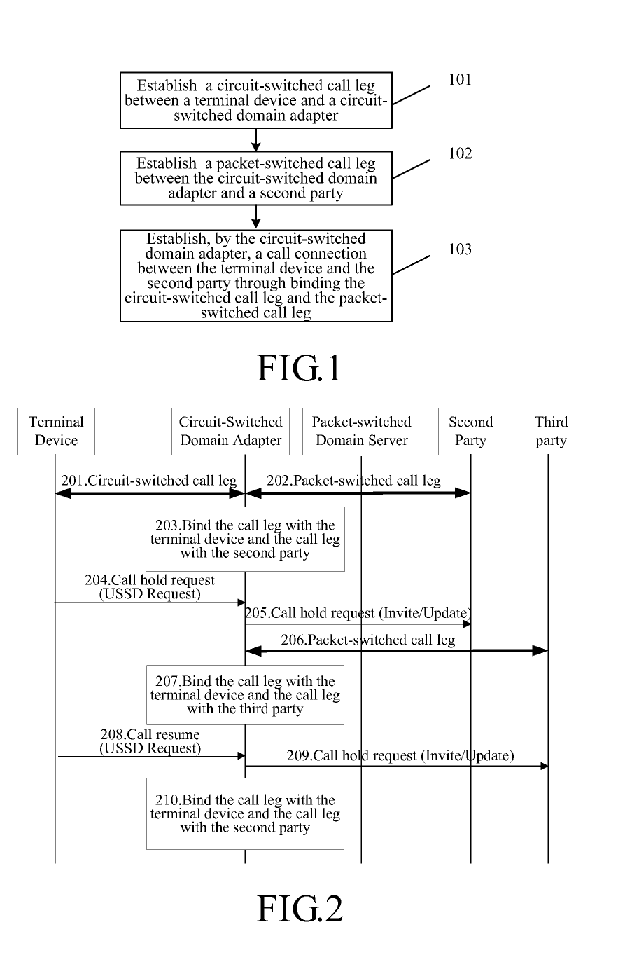

A signaling flowchart of a call control method is shown in FIG. 2, which includes the following steps.

In step 201, a circuit-switched call leg is established between a terminal device and a circuit-switched domain adapter.

In step 202, a packet-switched call leg is established between the circuit-switched domain adapter and a second party under the control of a packet-switched domain server.

It would be appreciated that the packet network involved in the embodiment of the present invention may be an IMS network in which the packet-switched call employs Session Initial Protocol (SIP) and the packet-switched call leg is a SIP call leg.

In step 203, the circuit-switched domain adapter establishes a call connection between the terminal device and the second party by binding the circuit-switched call leg and the packet-switched call leg.

In step 204, the terminal device transmits a call hold request containing an identification of a third party to the circuit-switched domain adapter through a circuit-switched network.

The identification of the third party may be the third party's SIP Uniform Resource Identifier (URI), Telephone URI (Tel URI), Internet Protocol (IP) address, telephone number or other identification information that may identify a user. The present invention is not limited by specific identification information.

In the present embodiment, the call hold request may be carried in an Unstructured Supplementary Service Data Request (USSD request) message transmitted to the circuit-switched domain adapter through the circuit-switched network.

It would be appreciated that the terminal device may also have PS access capability and the call hold request may also be transmitted to the circuit-switched domain adapter through a packet-switched access network. For example, the terminal device may transmit the call hold request to the circuit-switched domain adapter through existing General Packet Radio Service (GPRS) network, and the call hold request may be transmitted through an Invite or Update message.

In step 205, the circuit-switched domain adapter transmits the call hold request to the second party through the packet-switched domain server so as to hold the established call leg with the second party.

It would be appreciated that the two parties in the communication may transmit a call hold request to each other, and they would hold the current call after the other party agrees to hold.

It would be appreciated that the call hold request transmitted by the circuit-switched domain adapter to the second party may be carried in the Invite message or the Update message. The Invite message or Update message contains an identification instructing the second party to hold the established call leg with the circuit-switched domain adapter, and meanwhile, the packet-switched domain server may play a call hold tone for the second party to notify the user of the second party that the call is held. The hold operation means that a hold accepting party holds a call status with a hold request transmitting party but stops data transmission. In the present embodiment, the hold accepting party is the user terminal of the second party, and the hold request transmitting party is the circuit-switched domain adapter.

In step 206, a packet-switched call leg is established between the circuit-switched domain adapter and the third party under the control of the packet-switched domain server.

In step 207, the circuit-switched domain adapter establishes a call connection between the terminal device and the third party by binding the circuit-switched call leg and the call leg with the third party.

It would be appreciated that the following steps may be further included in the method after step 207.

In step 208, the terminal device may also request a call resume with the second party from the circuit-switched domain adapter.

The terminal device transmits a call resume request with the second party to the circuit-switched domain adapter through a packet-switched access network or a circuit-switched network.

In step 209, the circuit-switched domain adapter requests the third party to hold the established call leg with the third party.

The manner of holding the established call leg with the third party is identical with the manner of holding the established call leg with the second party in step 205.

In step 210, the circuit-switched domain adapter resumes the call connection between the terminal device and the second party by binding the established call leg with the terminal device and the established call leg with the second party.

It would be appreciated that in the present embodiment, the terminal device may continue to request a call resume from the circuit-switched domain adapter so as to realize the communication switching of the terminal device between the second party and the third party.

On the basis of the first embodiment, the second embodiment of the present invention realizes that a packet-switched network service platform provides a call hold service for the circuit-switched network terminal device. By reusing the circuit-switched call leg between the circuit-switched domain adapter and the terminal device, the implementation of the procedure of the call hold service becomes easier, thus saving CS network resources and decreasing the establishing time of a call connection.

### Third Embodiment

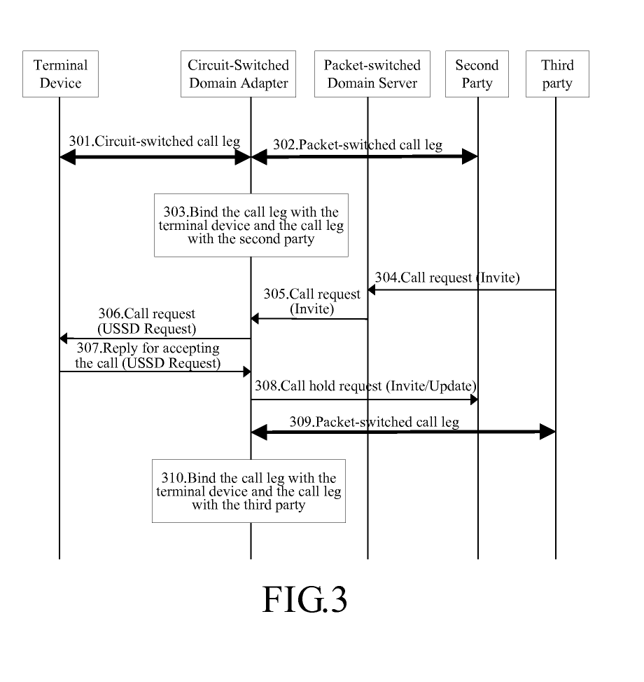

A signaling flowchart of a call control method is shown in FIG. 3, which includes the following steps.

In step 301, a circuit-switched call leg is established between a terminal device and a circuit-switched domain adapter.

In step 302, a packet-switched call leg is established between the circuit-switched domain adapter and a second party under the control of a packet-switched domain server.

In step 303, the circuit-switched domain adapter establishes a call connection between the terminal device and the second party by binding the established call leg with the terminal device and the established call leg with the second party.

In step 304, a third party transmits a call request intended for the terminal device to the packet-switched domain server.

In the present embodiment, the call request is an Invite message which contains an identification of the terminal device.

In step 305, the packet-switched domain server transmits the call request to the circuit-switched domain adapter.

It would be appreciated that the packet-switched domain server receives the call request and performs an initial Filter Criteria (iFC) check. If it is determined that the call request is intended for the circuit-switched domain terminal device, that is, the call is to be established through a circuit-switched network, the packet-switched domain server routes the call request to the circuit-switched domain adapter.

The iFC is a part of user subscribing information, which is service trigger information. The iFC is used to describe under what conditions an incoming SIP message is further routed to a specific application server. Typically, the SIP message may be an Invite message requesting to establish a call or a Register message for IMS registration.

In step 306, the circuit-switched domain adapter delivers the call request of the third party to the terminal device.

In the present embodiment, the delivered call request may be delivered to the terminal device through a circuit-switched network USSD Request message, and may also be delivered to the terminal device through a packet-switched access network.

In step 307, the terminal device transmits a reply for accepting the call to the circuit-switched domain adapter.

In the present embodiment, the reply may be transmitted to the circuit-switched domain adapter through a circuit-switched network USSD Request message, and may also be transmitted to the circuit-switched domain adapter through the packet-switched access network.

In step 308, the circuit-switched domain adapter receives the reply and transmits a call hold request to the second party to hold the established call leg with the second party.

The manner of holding the established call leg with the second party may be referred to step 205 in the second embodiment.

In step 309, a packet-switched call leg is established between the circuit-switched domain adapter and the third party under the control of the packet-switched domain server.

In step 310, the circuit-switched domain adapter establishes a call connection between the terminal device and the third party by binding the established call leg with the terminal device and the established call leg with the third party.

It would be appreciated that after step 310, the terminal device may request a call resume from the circuit-switched domain adapter so as to realize the communication switching of the terminal device between the second party and the third party. Specific switching manner may be referred to steps 208 to 210 in the second embodiment.

It would be appreciated that the order between step 309 and steps 305 to 308 is not limited. It is also possible that after step 304 in which the circuit-switched domain adapter receives the call request of the third party, step 309 is performed, in which the packet-switched call leg is established between the circuit-switched domain adapter and the third party under the control of the packet-switched domain server. If the terminal device returns the reply for accepting the call of the third party in step 307, the process proceeds to step 308. If the terminal device rejects to communicate with the third party, the circuit-switched domain adapter may clear the established call leg with the third party in subsequent steps.

The third embodiment of the present invention differs from the second embodiment in that the terminal device receives the call request of the third party during the communication with the second party, and if the terminal device accepts the call request, it holds the call connection with the second party and establishes the call connection with the third party. By reusing the circuit-switched call leg, it is realized that a packet-switched platform provides a call waiting service for the circuit-switched terminal device.

### Fourth Embodiment

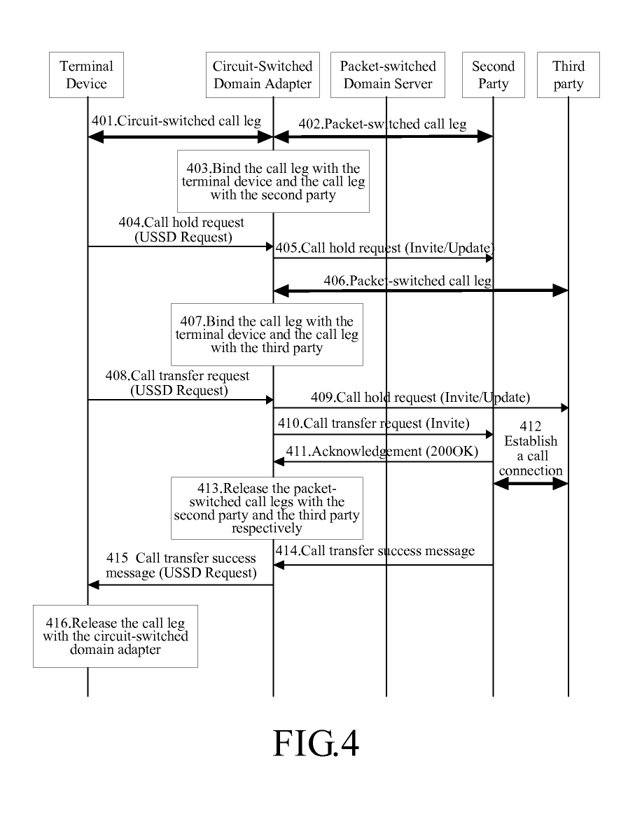

A signaling flowchart of a call control method is shown in FIG. 4, which includes the following steps.

Steps 401 to 407 in the present embodiment are identical with steps 201 to 207 in the second embodiment described above and thus are not further described here.

In step 408, the terminal device transmits a call transfer request to the circuit-switched domain adapter.

The terminal device may transmit the call transfer request to the circuit-switched domain adapter through a packet-switched access network or a circuit-switched network.

In step 409, the circuit-switched domain adapter transmits a call hold request to the third party to hold the established call leg with the third party.

In step 410, the circuit-switched domain adapter transmits the call transfer request to the second party, in which the call transfer request contains an identification of the third party.

The call transfer request may be transmitted through an Invite message.

In step 411, the second party accepts the call transfer request and returns an acknowledge message to the circuit-switched domain adapter.

The acknowledge message may be returned through a 200OK message.

In step 412, the second party and the third party establish a call connection.

Specifically, the second party and the third party may use conventional existing methods to establish the call connection, which are not further described here.

Steps 410 to 412 are a specific implementation for the circuit-switched domain adapter to control the second party and the third party to establish the call connection. It would be appreciated that the circuit-switched domain adapter may also realize the establishment of the call connection between the second party and the third party by binding the established call legs between the circuit-switched domain adapter and the second or third party. The present invention is not limited by specific manners of establishing the call connection between the second party and the third party.

After step 411, the established packet-switched call legs between the circuit-switched domain adapter and the second or third party respectively are released in step 413.

In step 414, after the call connection between the second party and the third party is established successfully, the second party returns a call transfer success message to the circuit-switched domain adapter.

In step 415, the circuit-switched domain adapter transmits a USSD Request message to the terminal device through a circuit-switched network, in which the USSD Request message contains an identification indicating that the call transfer is successful.

It would be appreciated that the circuit-switched domain adapter may also notify the terminal device of the call transfer success message through a packet-switched network.

In step 416, the terminal device releases the established call leg with the circuit-switched domain adapter after receiving the call transfer success message.

It would be appreciated that steps 401 to 407 in the present embodiment may be replaced with steps 301 to 310 in the third embodiment.

On the basis of the methods of the second or third embodiment, the fourth embodiment of the present invention realizes a method for a packet-switched control platform to provide a call transfer service for the circuit-switched terminal device.

### Fifth Embodiment

A signaling flowchart of a call control method is shown in FIG. 5, which includes the following steps.

In step 501, a circuit-switched call leg is established between a terminal device and a circuit-switched domain adapter.

In step 502, a packet-switched call leg is established between the circuit-switched domain adapter and the second party under the control of a packet-switched domain server.

In step 503, the circuit-switched domain adapter establishes a call connection between the terminal device and the second party by binding the established call leg with the terminal device and the established call leg with the second party.

In step 504, the terminal device transmits a call transfer request to the circuit-switched domain adapter, in which the call transfer request includes an identification of a third party.

The terminal device may transmit the call transfer request to the circuit-switched domain adapter through a packet-switched access network or a circuit-switched network.

In step 505, the circuit-switched domain adapter transmits a call hold request to the second party to hold the established call leg with the second party.

Steps 506 to 508 are steps in which the circuit-switched domain adapter controls the second party and the third party to establish a call connection, which are identical with steps 410 to 412 in the fourth embodiment and thus are not further described here.

In step 509, after the second party returns an acknowledge message for accepting the call transfer, the circuit-switched domain adapter releases the established packet-switched call leg with the second party.

In step 510, after the call connection between the second party and the third party is established successfully, the second party returns a call transfer success message to the circuit-switched domain adapter.

In step 511, the circuit-switched domain adapter transmits the call transfer success message to the terminal device through the circuit-switched network. The call transfer success message may be transmitted through a USSD Request message which contains an identification indicating that the call transfer is successful.

It would be appreciated that the circuit-switched domain adapter may also notify the terminal device of the call transfer success message through the packet-switched network.

In step 512, the terminal device releases the established circuit-switched call leg with the circuit-switched domain adapter after receiving the call transfer success message.

The fifth embodiment of the present invention differs from the fourth embodiment in that: the circuit-switched domain adapter does not establish a call leg with the third party; the terminal device directly transmits the call transfer request and notifies the circuit-switched domain adapter of the identification of the third party to be transferred to; and the second party establishes the call connection with the third party so as to realize the call transfer.

### Sixth Embodiment

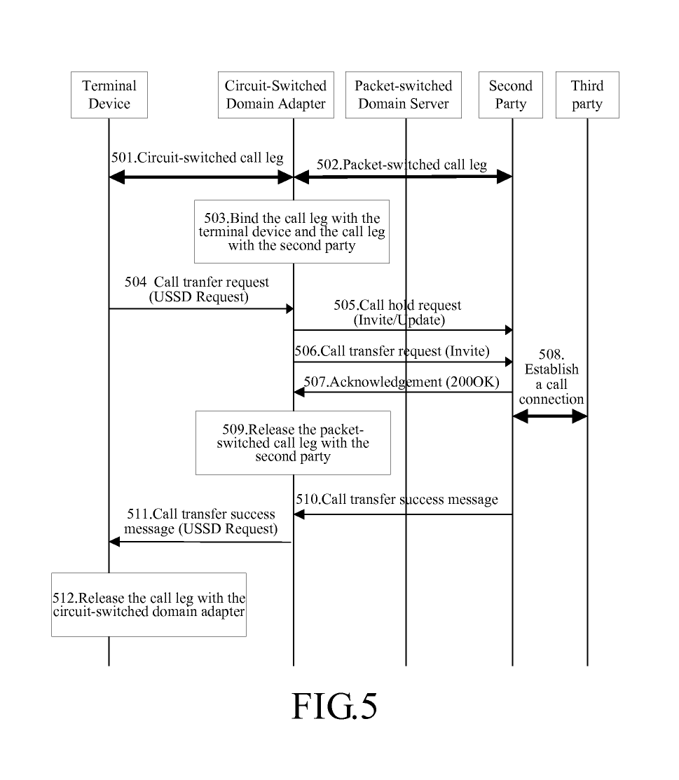

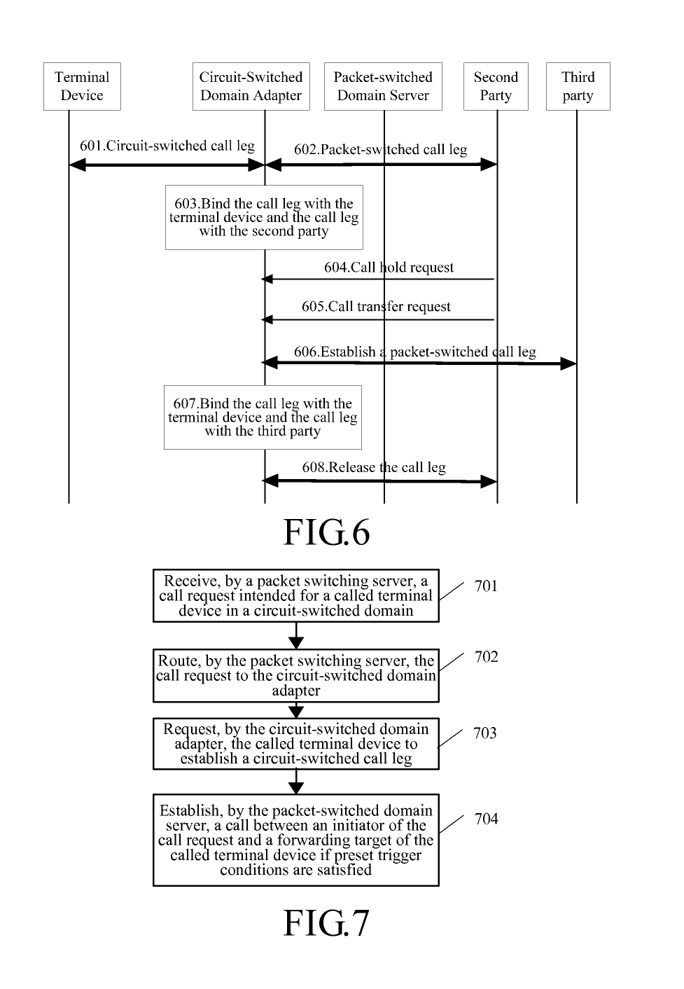

A signaling flowchart of a call control method is shown in FIG. 6, which includes the following steps.

In step 601, a circuit-switched call leg is established between a terminal device and a circuit-switched domain adapter.

In step 602, a packet-switched call leg is established between the circuit-switched domain adapter and a second party under the control of a packet-switched domain server.

In step 603, the circuit-switched domain adapter establishes a call connection between the terminal device and the second party by binding the established call leg with the terminal device and the established call leg with the second party.

In step 604, the second party transmits a call hold request to the circuit-switched domain adapter to hold the established call leg with the circuit-switched domain adapter.

In step 605, the second party transmits a call transfer request to the circuit-switched domain adapter, in which the call transfer request contains an identification of a third party.

In step 606, a packet-switched call leg is established between the circuit-switched domain adapter and the third party under the control of the packet-switched domain server.

In step 607, the circuit-switched domain adapter establishes a call connection between the terminal device and the third party by binding the established call leg with the terminal device and the established call leg with the third party.

In step 608, the circuit-switched domain adapter interacts with the second party to release the established call leg with the second party.

In the sixth embodiment of the present invention, the call transfer request is initiated by the second party, the terminal device establishes the call connection with the third party, and the second party exits the call. It is realized that a packet-switched platform provides a passive call transfer service for the circuit-switched network terminal device.

### Seventh Embodiment

A flowchart of a call control method is shown in FIG. 7, which includes the following steps.

In step 701, a packet-switched domain server receives a call request intended for a called terminal device in a circuit-switched domain.

It would be appreciated that the packet-switched domain server performs an iFC check after receiving the call request. If it is checked that the call request is intended for the circuit-switched domain terminal device, the packet-switched domain server routes the call request to a circuit-switched domain adapter.

In step 702, the packet-switched domain server routes the call request to the circuit-switched domain adapter.

In step 703, the circuit-switched domain adapter requests the called terminal device to establish a circuit-switched call leg.

Specifically, requesting to establish the circuit-switched call leg may include: transmitting, by the circuit-switched domain adapter, an Invite message to a media gateway controller; transmitting, by the media gateway controller, an Initial Address Message (IAM) to a Mobile Switching Center (MSC) that provides services for the called terminal device; and transmitting, by the MSC, a call setup message to the called terminal device.

It would be appreciated that the circuit-switched domain adapter may transmit the calling party's call request to the called terminal device through a circuit-switched network, during which various implementations are possible for specific transmitted messages and message transmission paths. The present invention is not limited by specific transmitted messages and message transmission paths.

In step 704, if preset trigger conditions are satisfied, the packet-switched domain server establishes a call between an initiator of the call request and a forwarding target of the called terminal device.

In the embodiment of the present invention, the preset trigger conditions may include any one of or any combination of the following four conditions.

First condition: The packet-switched domain server receives a message, indicating that the called terminal device is busy, returned by the called terminal device through the circuit-switched domain adapter.

It would be appreciated that the fact that the called user terminal device is busy may mean that: after the called terminal device receives the call establishing request, the user rejects the communication through certain operations and returns the message indicating that the called terminal device is busy; or after the MSC receives the call request, the MSC detects that the called terminal device is being in communication and then directly returns the message indicating that the called terminal device is busy.

Second condition: The packet-switched domain server receives a forwarding request message returned by the called terminal device through the circuit-switched domain adapter, in which the forwarding request message contains an identification of the forwarding target.

The user may transmit the request for forwarding the current call to the packet-switched domain server through the called terminal, and the packet-switched domain server may perform the operation of forwarding according to the forwarding target specified by the called terminal device.

Third condition: The circuit switching server fails to receive a temporary response message, for the call request, returned by the called terminal device through the circuit-switched domain adapter in a preset period, that is, the circuit switching server can not communicate with the called terminal device.

Fourth condition: The circuit switching server fails to receive a reply message, for accepting the call, returned by the called terminal device through the circuit-switched domain adapter in a preset period.

Four trigger conditions for call forwarding are provided above. It would be appreciated that the trigger conditions for call forwarding may be appropriately set according to specific circumstances and service implementations, and the present invention is not limited by specific trigger conditions.

The seventh embodiment of the present invention realizes that a packet-switched network platform provides a forwarding service for the circuit-switched network called terminal device. During the process of evolving from the circuit-switched network to the packet-switched network, network building costs are reduced and network resources are saved by centrally controlling the forwarding service by the packet-switched network.

### Eighth Embodiment

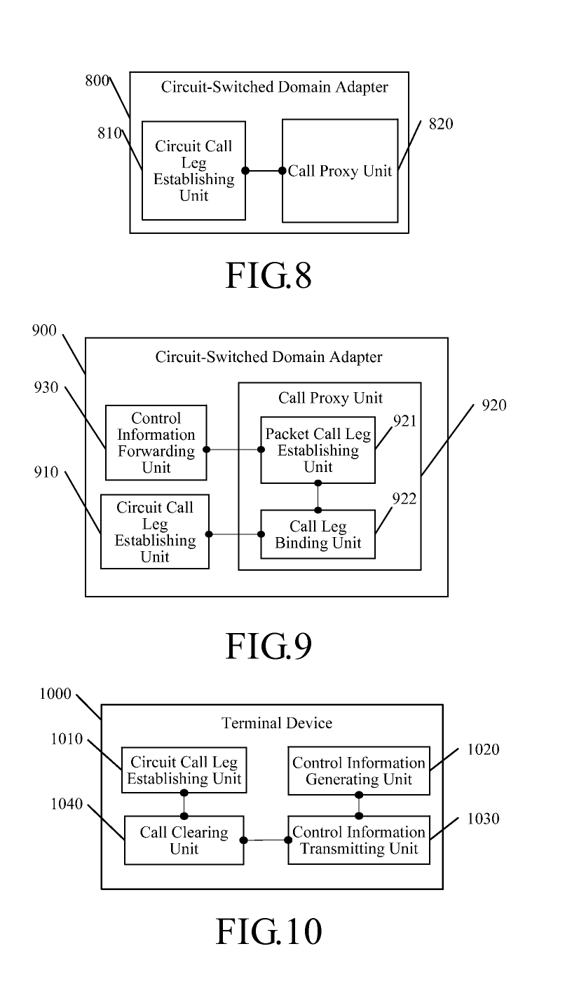

FIG. 8 shows a schematic diagram of a circuit-switched domain adapter 800. Circuit-switched domain adapter 800 includes a circuit call leg establishing unit 810 and a call proxy unit 820.

The circuit call leg establishing unit 810 is configured to establish a circuit-switched call leg with a terminal device.

The call proxy unit 820 is configured to establish a packet-switched call connection with the opposite end of the terminal device under the control of a packet-switched domain server.

The opposite end may consist of the second party or the third party described in the first to seventh embodiments, specifically, it may be a communication device communicating with the terminal device, such as a mobile phone, a computer, a server and so on.

### Ninth Embodiment

FIG. 9 shows a schematic diagram of a circuit-switched domain adapter 900. Circuit-switched domain adapter 900 includes a circuit call leg establishing unit 910 and a call proxy unit 920. Preferably, the circuit-switched domain adapter 900 may also include a control information forwarding unit 930. The call proxy unit 920 includes a packet call leg establishing unit 921 and a call leg binding unit 922.

The circuit call leg establishing unit 910 is configured to establish a circuit-switched call leg with a terminal device. The call proxy unit 920 is configured to, as a proxy of the terminal device, establish a packet-switched call connection with a second party in a packet-switched domain.

The packet call leg establishing unit 921 is configured to establish a packet-switched call leg with the second party under the control of a packet-switched domain server.

The call leg binding unit 922 is configured to establish a call connection between the terminal device and the second party by binding the call leg established with the terminal device and the call leg established with the opposite end.

The control information forwarding unit 930 is configured to receive control information of the terminal device and forward the control information of the terminal device to the second party through the packet-switched call leg established by the packet call leg establishing unit 921.

Specific implementations of the functions of the units in the circuit-switched domain adapter 900 may be referred to the implementation process of corresponding steps in the above-mentioned methods and thus are not further described here.

### Tenth Embodiment

FIG. 10 shows a schematic diagram of a terminal device 1000. Terminal device 1000 includes a circuit call leg establishing unit 1010, a control information generating unit 1020, a control information transmitting unit 1030 and a call clearing unit 1040.

The circuit call leg establishing unit 1010 is configured to establish a circuit-switched call leg with a circuit-switched domain adapter.

The control information generating unit 1020 is configured to generate call control information intended for the circuit-switched domain adapter after the circuit-switched call leg is established.

The control information transmitting unit 1030 is configured to transmit the call control information generated by the control information generating unit 1020 to the circuit-switched domain adapter through a packet-switched access network or a circuit-switched network.

The call clearing unit 1040 is configured to receive a call clearing request of the circuit-switched domain adapter and clear the circuit-switched call leg established by the circuit call leg establishing unit 1010.

Specific implementations of the functions of the units in the above-mentioned device may be referred to the implementation process of corresponding steps in the above-mentioned methods and thus are not further described here.

As will be apparent to one of ordinary skill in the art, the various “units” contained within the devices described above are logical entities that may be physically implemented with shared or separate components using hardware (e.g., processors or ASICs) or a combination of hardware and software.

Detail description has been given above with respect to the call control method, circuit-switched domain adapter and terminal device proposed by the embodiments of the present invention.

Embodiments of the present invention realize a call control to a circuit-switched terminal device by a packet-switched control platform by establishing a circuit-switched call leg between the terminal device and a circuit-switched domain adapter, and establishing a packet-switched call connection between the circuit-switched domain adapter, which operates as a proxy of the terminal device, and a second party under the control of a packet-switched domain server. Call control functions of a circuit-switched network are abandoned and a call control service is provided for the circuit-switched domain terminal device by the packet-switched domain server, thus centralizing control functions of the whole network, reducing network operation costs and making introduction of new services easier.

Further, embodiments of the present invention realize a packet-switched network service platform that provides supplementary services, such as call hold, call waiting and call transfer, for a circuit-switched network terminal device. By reusing a circuit-switched call leg between a circuit-switched domain adapter and the terminal device, the implementation of a second call connection becomes easier, thus saving CS network resources and decreasing the establishing time of a call connection.

In addition, embodiments of the present invention realize a packet-switched network platform that provides a forwarding service for a circuit-switched network called terminal device. During the process of evolving from a circuit-switched network to a packet-switched network, network building costs and network resources are saved by centrally controlling the forwarding service by the packet-switched network.

Although the present invention has been described with reference to specific features and embodiments thereof, it is evident that various modifications and combinations can be made thereto without departing from the spirit and scope of the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A call control method, comprising:
establishing a circuit-switched call leg with a terminal device;
establishing a packet-switched call leg with a second party; and
establishing a call connection between the terminal device and the second party by binding the circuit-switched call leg and the packet-switched call leg with the second party.

2. The call control method according to claim 1, wherein after establishing the call connection, the method further comprises:
receiving a call request transmitted by a third party to the terminal device through a packet-switched domain server;
delivering the call request to the terminal device;
holding the packet-switched call leg with the second party;
establishing a packet-switched call leg with the third party; and
establishing a call connection between the terminal device and the third party by binding the circuit-switched call leg and the packet-switched call leg with the third party.

3. The call control method according to claim 1, wherein after establishing the call connection, the method further comprises:
receiving a call hold request transmitted by the terminal device;
holding the packet-switched call leg with the second party;
receiving a call request containing an identification of a third party transmitted by the terminal device;
establishing a packet-switched call leg with the third party; and
establishing a call connection between the terminal device and the third party by binding the circuit-switched call leg and the packet-switched call leg with the third party.

4. The call control method according to claim 2, further comprising:
receiving a call resume request transmitted by the terminal device;
holding the packet-switched call leg with the third party; and
resuming the call connection between the terminal device and the second party by binding the circuit-switched call leg and the packet-switched call leg with the second party.

5. The call control method according to claim 3, further comprising:
receiving a call resume request transmitted by the terminal device;
holding the packet-switched call leg with the third party; and
resuming the call connection between the terminal device and the second party by binding the circuit-switched call leg and the packet-switched call leg with the second party.

6. The call control method according to claim 1, wherein the method further comprises:
receiving a call transfer request containing an identification of a third party transmitted by the terminal device;
transmitting the call transfer request to the second party;
controlling the second party and the third party to establish a call connection; and
releasing the packet-switched call leg and the circuit-switched call leg.

7. The call control method according to claim 2, wherein the method further comprises:
receiving a call transfer request containing an identification of the third party transmitted by the terminal device;
transmitting the call transfer request to the second party;
controlling the second party and the third party to establish a call connection; and
releasing the packet-switched call leg and the circuit-switched call leg.

8. The call control method according to claim 3, wherein the method further comprises:
receiving a call transfer request containing an identification of the third party transmitted by the terminal device;
transmitting the call transfer request to the second party;
controlling the second party and the third party to establish a call connection; and
releasing the packet-switched call leg and the circuit-switched call leg.

9. The call control method according to claim 1, wherein the method further comprises:
receiving a call transfer request containing an identification of a third party transmitted by the second party;
establishing a packet-switched call leg with the third party; and
establishing a call connection between the terminal device and the third party by binding the circuit-switched call leg and the packet-switched call leg with the third party.

10. An apparatus for performing call control in a communications network, comprising:
a circuit call leg establishing unit, configured to establish a circuit-switched call leg with a terminal device;
a packet call leg establishing unit, configured to establish a packet-switched call leg with a second party; and
a call leg binding unit, configured to establish a call connection between the terminal device and the second party by binding the circuit-switched call leg and the packet-switched call leg with the second party.

11. The apparatus according to claim 10, further comprising:
a control information forwarding unit, configured to receive a call request transmitted by a third party to the terminal device through a packet-switched domain server and forward the call request to the terminal device through the circuit-switched call leg established by the circuit call leg establishing unit.

12. The apparatus according to claim 11, wherein:
the packet call leg establishing unit is further configured to establish a packet-switched call leg with the third party; and
the call leg binding unit is further configured to hold the packet-switched call leg with the second party and establish a call connection between the terminal device and the third party by binding the circuit-switched call leg and the packet-switched call leg with the third party.

13. The apparatus according to claim 10, wherein the circuit call leg establishing unit, the packet call leg establishing unit and the call leg binding unit are implemented using one or more shared hardware components and one or more shared software components.

14. A method for performing call control in a communications network, comprising:
receiving a call request transmitted to a called terminal device in a circuit-switched domain;
routing the call request to a circuit-switched domain adapter, wherein the circuit-switched domain adapter is adapted to send a request to the called terminal device to establish a circuit-switched call leg; and
establishing a call between an initiator of the call request and a forwarding target of the called terminal device if a message which is returned by the called terminal device and received by the packet-switched domain server through the circuit-switched domain adapter satisfies one or more preset trigger conditions.

15. The method according to claim 14, wherein the receiving, routing and establishing steps are performed by an application server.

16. A terminal device for a communications network, comprising,
a circuit call leg establishing unit configured to establish a circuit-switched call leg with a circuit-switched domain adapter;
a control information generating unit configured to generate call control information intended for the circuit-switched domain adapter after the circuit-switched call leg is established; and
a control information transmitting unit configured to transmit the call control information generated by the control information generating unit to the circuit-switched domain adapter through a packet-switched access network or a circuit-switched network.

17. The terminal device according to claim 16, wherein the circuit call leg establishing unit, the control information generating unit and the control information transmitting unit are implemented using one or more shared hardware components and one or more shared software components.
